(19) United States
(12) Patent Application Publication
(10) Pub. No.: US 2012/0265519 A1
(43) Pub. Date: Oct. 18, 2012

(54) SYSTEM AND METHOD FOR OBJECT DETECTION

(75) Inventor: Simon Latendresse, Montreal (CA)

(73) Assignee: DOW JONES & COMPANY, INC., New York, NY (US)

(21) Appl. No.: 13/164,054

(22) Filed: Jun. 20, 2011

Related U.S. Application Data
(60) Provisional application No. 61/475,309, filed on Apr. 14, 2011.

(51) Int. Cl. G06F 17/27

(52) U.S. Cl. 704/9; 704/E15.018

(57) ABSTRACT

A system and method for object detection is provided, which system and method combines parsing and classification technologies for extracting objects, e.g., events, entities or the like, from text. In exemplary embodiment, the output of a parsing technique is transformed into a model suitable as input for classification in order to provide event or entity detection results.

### CROSS REFERENCE TO RELATED APPLICATIONS

The present application claims priority to U.S. Provisional Patent Application Ser. No. 61/475,309, filed Apr. 14, 2011, the entire contents of which are specifically incorporated by reference herein.

### BACKGROUND

The present disclosure relates to systems and methods for extracting objects, including events, entities or the like, from text.

The standard way to extract such objects is to use a simple pattern language. An example of simple pattern language extraction involves a programmer writing a pattern that would say “if the sentence contains a company, then the verb ‘announce’, then the words ‘financial results’, then this means this is a financial announcement.”

One of the main problems of using a pattern language is the fact that the target words of a pattern are rarely next to each other in the text being analyzed, a typical sentence rather reads “Acme Inc. yesterday announced their latest financial results.” So the programmer must decide how many words will be allowed between each element in the pattern, but there is no exact number that will work for all cases. Therefore some events will be missed because they contain too many extra words, e.g., “Acme Inc., the world leader in widgets and gadgets, yesterday announced . . . .” Conversely, if too many words are allowed, then some sentences are incorrectly labeled as events.

Natural language parsing can be used to help solve the problem. The parsing takes a sentence as input and outputs a model of the sentence that captures its structure. The model can identify the subject of the sentence, its verb and complements among other things. Yet this still leaves some problems. For example, if the analyzed sentence is “Acme Inc. announced its results yesterday”, the natural language parsing still will not know what the mentioned results are. The result will not take into account whether such results are financial results or of other kinds of results (e.g. test results). The sentence might suggest that this is probably a financial result, but there is no way to be sure.

What is needed in the art are more advanced systems and methods (beyond simple parsing) that remove such uncertainties and provide more accurate object detection results.

### SUMMARY

The above described and other problems and deficiencies in the art are overcome and alleviated by the present system and method, which system and method advantageously combines parsing and classification technologies for extracting objects from text. In exemplary embodiments, such objects include events, entities or the like. In exemplary embodiment, the output of a parsing technique is transformed into a model suitable as input for classification in order to provide object detection results.

In an exemplary embodiment, a computer program identifies news articles that discuss specific types of business events or entities. The program reads in the articles one at a time, parses the text using natural language processing techniques, transforms the output of that process into a mathematical model representing the meaning of the text, then classifies that model into one or many predefined categories. Exemplary categories for business events include financial announcements, merger and acquisition, etc., although any type of categories may be defined.

Thus, the present system and method provide a mechanism that combines parsing with classification for extracting objects from text.

### BRIEF DESCRIPTION OF THE DRAWINGS

Referring now to the drawings, wherein like elements are numbered alike in the following FIGURES:

FIG. 1 illustrates a flow chart of an exemplary system and method of providing object detection using parsing and classification techniques;

FIG. 2 provides an exemplary document upon which object detection will be performed;

FIG. 3 illustrates the separation of the exemplary document of FIG. 2 into four separate sentences;

FIG. 4 illustrates an exemplary output of an exemplary parsing process for each of the four sentences of FIG. 3;

FIG. 5 provides an exemplary list of concepts derived from the parsing process of the four sentences of FIG. 3;

FIG. 6 provides an exemplary output defining an event relative to a company; and

FIG. 7 provides an exemplary scored output for a Financial Announcement classifier.

### DETAILED DESCRIPTION

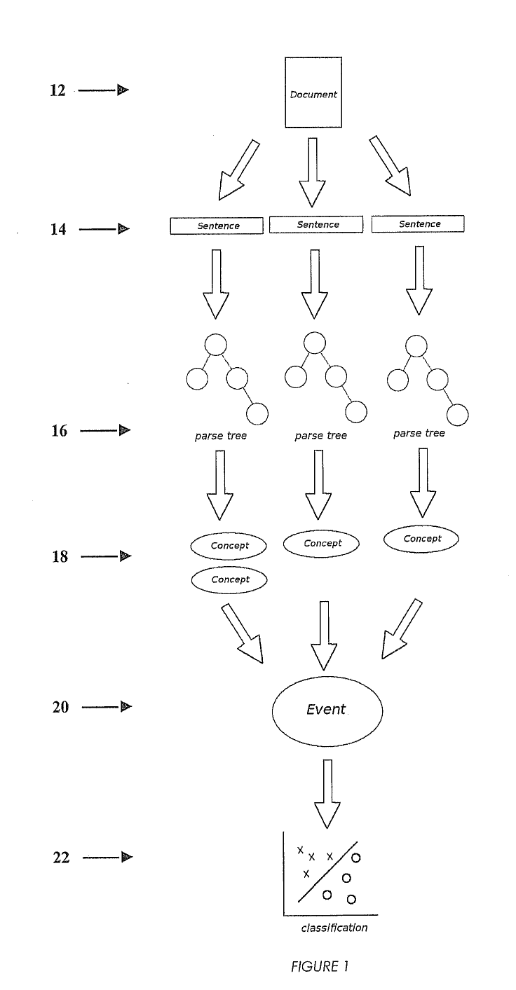

As was noted above, the present disclosure relates to system and method of providing object detection using parsing and classification techniques. As used herein, the term “object” refers to an event, entity or the like. FIG. 1 provides a flow chart of an exemplary embodiment of such system and method.

Referring to FIG. 1, an exemplary system and method first splits an incoming document 12 into sentences 14. Each sentence is then analyzed by a natural language parser. The parser identifies the role of each word in the sentence (noun, adjective, etc.) and groups the words into logical elements (e.g. the words “the black cat” are grouped together as a noun group). The output of the parse is a parse tree 16, an acyclic graph that connects the groups based on their relationship in the sentence. The subject points to the verb, the verb to its complements, a noun points to its modifiers, etc.

### Example 1

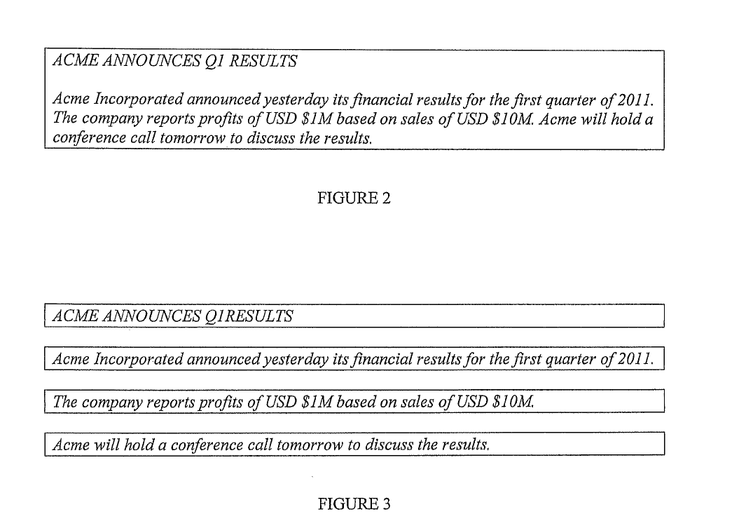

A specific example of the above is also provided at FIGS. 2-4, and will be continued where appropriate below to further exemplify other aspects of the present disclosure. It should be understood that this is merely a working example, and should not be construed to limit the scope of the invention.

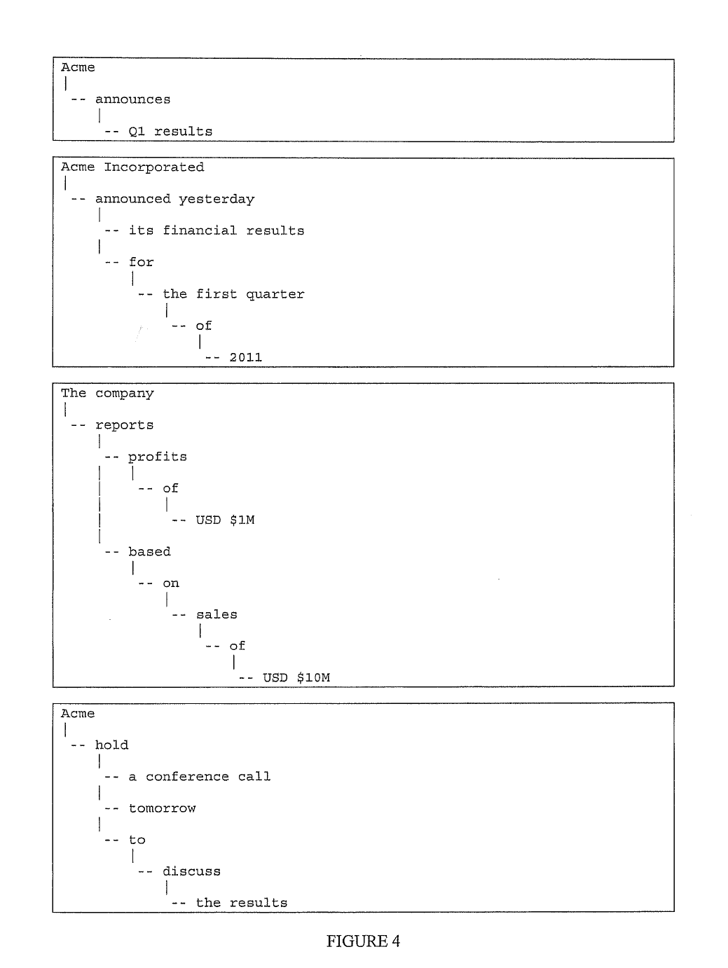

In this example, a small document is provided at FIG. 2. This document corresponds to document 12 in FIG. 1. At FIG. 3 and at 14 in FIG. 1, this document is split into four separate sentences. FIG. 4 illustrates a parsing process applied separately to each of those four sentences. The output of this process is a parse tree for each sentence, also illustrated at 16 in FIG. 1.

In an exemplary next step, the system and method examines the parse tree to create concepts 18. Concepts are another kind of group, since they join together one or many word groups. A typical concept may be made up of a subject, a verb and a complement.

The following is an example to illustrate the process. Consider the first sentence from the above example, “Acme announces Q1 results”. With regard to the first box of FIG. 4, the output of the parser for the first sentence may provide three groups: “Acme” “announces” and “Q1 results.” The parser may also identify that “Acme” is the subject, “announces” is the verb, “Q1” is a modifier, and the complement is “results.”

The present system and method may process each sentence of the document and create zero, one or many concepts for each sentence.

### Continuation of Example 1

Continuing to follow the specific example provided at FIGS. 2-4, for each parse tree, one or more concepts are created (here, grouped based on the parse tree that generated them). FIG. 5 provides plural concepts derived from the parsing process of FIG. 4. These plural concepts are illustrated at 18 in FIG. 1.

In this exemplary embodiment, from this point on, the main actor of the concept is replaced with an X. This is done so that “Acme announces results” and “Dow Jones announces results” both generate identical concepts. The text in the concepts is also normalized: the singular form is used and only the head of each noun group is used (e.g. its financial results become simply result). Thus, the concept generated from the first parse tree in FIG. 4 becomes “X announce result” in FIG. 5.

The concepts generated from the parsing process may then be grouped according to the actor involved (in our example, Acme). This group of concepts is referred to herein as an event, illustrated at 20 in FIG. 1.

The presently described system and method allows us to identify the news articles that describe specific types of events (e.g., business events). The event types are configurable and the system can be retrained to add new types of events. Without limitation, examples of business event types follow:

Merger and acquisition

Business partnership

Stock split

New funding

Financial rating announcement

Financial results announcement

Bankruptcy

Product announcement

Licensing agreement

Security breach

Lawsuit

Management change

New business location

For a given document, the an exemplary system and method in accordance with the present disclosure outputs a set of event types, in effect telling us whether that document mentions a merger and acquisition, or a lawsuit, or a management change, etc. The system and method may also assign to each predicted event type the confidence level at which the prediction is made.

At this stage, the event 20 represents a summary of the actions of a given person or company in the document. The event says that in that particular document, Acme Inc. announced results, Acme Inc. posted profits, Acme Inc. earned X dollars, etc. Each mention of Acme Inc. in the document is thus represented by a concept.

### Continuation of Example 1

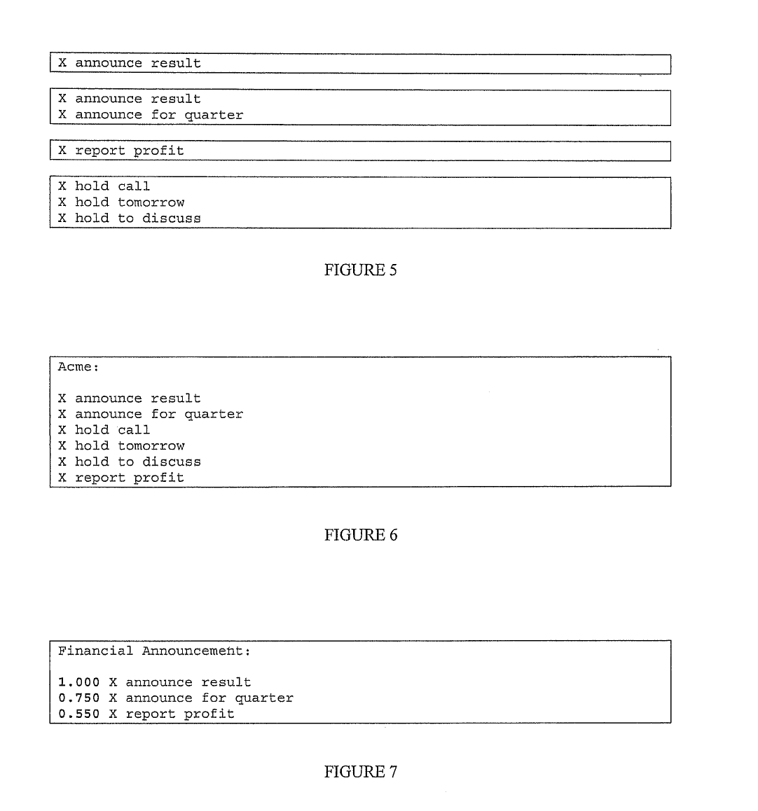

Continuing to follow the specific example provided at FIGS. 2-5, FIG. 6 shows concepts that have been grouped by company to define an event. This is illustrated at 20 in FIG. 1. In this example, because there is only a single company (“Acme”), all concepts are grouped together.

An event may then be fed to statistical classifiers, illustrated at 22 in FIG. 1, that identify the type of event. There is one classifier for each event type; each classifier is responsible to determine whether the event corresponds to that particular type. By way of example and without limitation, there may be a financial announcement classifier, a management change classifier, etc. At any point in the system and method, new classifiers can be added without having to change any existing ones.

### Continuation of Example 1

Continuing to follow the specific example provided at FIGS. 2-6, FIG. 7 illustrates the result from feeding the event to an LIBSVM classifier (see 22 in FIG. 1), which provides a series of scores assigned to each concept. The higher the score, the more likely it is that the concept is related to a financial announcement event. In this example, FIG. 7 shows the concept scores from a Financial Announcement classifier. The scores of the concepts that are present in the document are summed, and if that sum exceeds a given threshold, then the event is classified as a positive case: i.e. an event that describes a financial announcement.

In general, the implementations of the natural language parser and the classifier may be based on any known or suitable technologies. One exemplary parser suitable for the present system and method incorporates the concept learning algorithm in its methodology. One exemplary classifier suitable for the present system and method is LIBSVM (noted above in Example 1), which is an open source classifier implementing the support vector machine algorithm. The above described parser and classifier are merely exemplary, and the present system and method contemplate using other types of parsers and classifiers.

One exemplary natural language parser analyzes text via complex sentence models. An exemplary natural language parser may also combine features from different sentences in order to determine events. In other exemplary embodiments, machine learning is used to analyze text patterns for natural language parsing and statistical models are applied to account for uncertainty.

It should also be recognized that the present system and method can be extended to deal with more than just a predetermined list of event types. Event types could be created on the fly by the user, in effect meaning the invention would work with an infinite list of possible event types.

Further, as is noted above, the present system and method may extract other object types, for example entities such as organizations or persons. In such an exemplary embodiment, for a given document the system may be configured to output a set of entity types, indicating mentions of person names, organization names, product names, etc. The system and method may also assign to each predicted entity type the confidence level at which the prediction is made.

Further, the present system and method may be implemented to measure the similarity of documents since the classifiers use the similarity of documents as the basis for their classification. In such an implementation, the classifiers are removed and the system and method consider that unclassified events are the output of the invention. In such cases, these events can be compared with mathematical models to determine which ones are similar. This would be used for instance to group together similar documents, and/or to create a “More articles like this” section on a webpage when displaying a document.

Further, the concepts themselves can be used for searching. For instance, instead of searching for all documents that contain the words “Acme”, “announce” and “results”, the present system and method would allow the user to search for documents that contain a sentence where “Acme” is the subject, “announce” is the verb and “result” is the complement. This tool produces more precise search results than a simple keyword search.

It will be apparent to those skilled in the art that, while exemplary embodiments have been shown and described, various modifications and variations can be made to the system and method for object detection disclosed herein without departing from the spirit or scope of the invention. Accordingly, it is to be understood that the various embodiments have been described by way of illustration and not limitation.

What is claimed is:

1. A method for object detection, comprising:
providing a program configured to access documents on a network, said program configured to parse the text of said documents using natural language processing;
wherein said natural language parser analyzes text via complex sentence models and identifies subjects, verbs, complements, nouns and modifiers;
transforming the output of said parsing into a mathematical model representing at least one meaning of the text; and
classifying said model into one or more categories.

2. A method in accordance with claim 1, wherein said program first splits an accessed document into sentences, which sentences are analyzed by said natural language parser.

3. A method in accordance with claim 2, wherein said parser identifies the role of each word in a sentence and groups the words into logical elements.

4. A method in accordance with claim 1, wherein said program uses natural language parsing information and utilizes concept learning techniques.

5. A method in accordance with claim 1, wherein said program uses natural language parsing information and combines features from plural sentences to determine events.

6. A method in accordance with claim 1, wherein said program uses natural language parsing information and uses machine learning to analyze text patterns.

7. A method in accordance with claim 1, wherein statistical models are applied to said parsing to account for uncertainty.

8. A method in accordance with claim 1, wherein an output of said parsing provides a parse tree as an acyclic graph that connects a plurality of groups based upon their relationship in a sentence.

9. A method in accordance with claim 8, wherein the parse tree is arranged such that a subject points to a verb, a verb points to one or more complements, and a noun points to one or more modifiers.

10. A method in accordance with claim 8, wherein said program examines said parse tree to create one or more concepts for a sentence.

11. A method in accordance with claim 10, wherein said one or more concepts comprise a subject, verb and compliment.

12. A method in accordance with claim 11, wherein the subject is treated as generic such that actions by multiple entities generate identical concepts.

13. A method in accordance with claim 12, wherein text in the concepts is normalized.

14. A method in accordance with claim 10, further comprising grouping of concepts to define an object.

15. A method in accordance with claim 14, wherein such concepts are grouped according to the subject to describe an event.

16. A method in accordance with claim 15, wherein said subject is an entity.

17. A method in accordance with claim 16, wherein said event represents a summary of the actions of a given entity described by a document.

18. A method in accordance with claim 15, wherein said program is configured to output a set of event types for a document.

19. A method in accordance with claim 18, wherein said set of event types is a set of business event types.

20. A method in accordance with claim 18, wherein said program is configured to accept user-defined event types.

21. A method in accordance with claim 18, wherein said program is configured to assign to each event type a confidence level at which a prediction is made.

22. A method in accordance with 15, wherein an event is fed to a statistical classifier configured to identify a predefined event to determine whether said event corresponds to that predefined classifier type.

23. A method in accordance with claim 17, wherein said program is configured to output a set of entity types for a document.

24. A method in accordance with claim 23, wherein said program is configured to assign to each entity type a confidence level at which a prediction is made.

25. A method in accordance with 23, wherein an entity is fed to a statistical classifier configured to identify a predefined entity to determine whether said entity corresponds to that predefined classifier type.

26. A method in accordance with claim 25, wherein said classifier is configured to provide a series of scores assigned to a plurality of concepts, wherein a higher score represents a higher likelihood that the concepts are related to a particular event.

27. A method in accordance with claim 26, wherein scores of concepts in a document are summed, and wherein the program is configured to classify an event as positive if the some exceeds a predetermined threshold.

28. A method in accordance with claim 25, wherein said classifier is a support vector machine classifier.

29. A method in accordance with claim 25, wherein said classifier is a LIBSVM classifier.

30. A system for object detection, comprising:
a storage medium attached to a network;
a program operating from said storage medium, the program configured to access documents on a network and to parse the text of said documents using natural language processing;
wherein said natural language processing analyzes text via complex sentence models and identifies subjects, verbs, complements, nouns and modifiers;
wherein the program is also configured to transform the output of said parsing into a mathematical model representing at least one meaning of the text and to classify said model into one or more categories.

31. A system in accordance with claim 30, wherein said program is configured to first split an accessed document into sentences, which sentences are analyzed by said natural language parser.

32. A system in accordance with claim 31, wherein a parsing aspect of said program is configured to identify the role of each word in a sentence and groups the words into logical elements.

33. A system in accordance with claim 30, wherein said program is configured to utilize natural language parsing information and to utilize concept learning techniques.

34. A system in accordance with claim 30, wherein said program is configured to utilize natural language parsing information and to combine features from plural sentences to determine events.

35. A system in accordance with claim 30, wherein said program is configured to utilize natural language parsing information and to use machine learning to analyze text patterns.

36. A system in accordance with claim 30, wherein said program is configured to apply statistical models to said parsing to account for uncertainty.

37. A system in accordance with claim 30, further comprising an output of said parsing aspect of said program generates a parse tree as an acyclic graph that connects a plurality of groups based upon their relationship in a sentence.

38. A system in accordance with claim 37, wherein the parse tree is arranged such that a subject points to a verb, a verb points to one or more complements, and a noun points to one or more modifiers.

39. A system in accordance with claim 37, wherein said program is configured to examine said parse tree to create one or more concepts for a sentence.

40. A system in accordance with claim 39, wherein said one or more concepts comprise a subject, verb and compliment.

41. A system in accordance with claim 40, wherein the program is configured such that the subject is treated as generic such that actions by multiple entities generate identical concepts.

42. A system in accordance with claim 41, wherein said program is further configured to normalize text in the concepts.

43. A system in accordance with claim 39, wherein said program is further configured to group concepts to define an object.

44. A system in accordance with claim 43, wherein the program is configured such that concepts are grouped according to the subject to describe an event.

45. A system in accordance with claim 44, wherein said subject is an entity.

46. A system in accordance with claim 45, wherein said event represents a summary of the actions of a given entity described by a document.

47. A system in accordance with claim 44, wherein said program is configured to output a set of event types for a document.

48. A system in accordance with claim 47, wherein said set of event types is a set of business event types.

49. A system in accordance with claim 47, wherein said program is configured to accept user-defined event types.

50. A system in accordance with claim 47, wherein said program is configured to assign to each event type a confidence level at which a prediction is made.

51. A system in accordance with 44, wherein said program is configured to feed an event to a statistical classifier configured to identify a predefined event to determine whether said event corresponds to that predefined classifier type.

52. A system in accordance with claim 46, wherein said program is configured to output a set of entity types for a document.

53. A system in accordance with claim 52, wherein said program is configured to assign to each entity type a confidence level at which a prediction is made.

54. A system in accordance with claim 53, wherein said program is configured to feed an event to a statistical classifier configured to identify a predefined entity to determine whether said entity corresponds to that predefined classifier type.

55. A system in accordance with claim 54, wherein said classifier is configured to provide a series of scores assigned to a plurality of concepts, wherein a higher score represents a higher likelihood that the concepts are related to a particular event.

56. A system in accordance with claim 55, wherein said program is configured such that scores of concepts in a document are summed, and wherein the program is configured to classify an event as positive if the some exceeds a predetermined threshold.

57. A system in accordance with claim 54, wherein said classifier is a support vector machine classifier.

58. A system in accordance with claim 54, wherein said classifier is a LIBSVM classifier.

59. A method for object detection, comprising:
providing a program configured to access documents on a network, said program configured to parse the text of said documents using natural language processing;
wherein said natural language parser analyzes text via complex sentence models and identifies subjects, verbs, complements, nouns and modifiers;
transforming the output of said parsing into a mathematical model representing at least one meaning of the text, wherein such output of said parsing provides a parse tree as an acyclic graph that connects a plurality of groups based upon their relationship in a sentence and wherein the parse tree is arranged such that a subject points to a verb, a verb points to one or more complements, and a noun points to one or more modifiers; and
classifying said model into one or more categories.

60. A method for object detection, comprising:
providing a program configured to access documents on a network, said program configured to parse the text of said documents using natural language processing;
wherein said natural language parser analyzes text via complex sentence models and identifies subjects, verbs, complements, nouns and modifiers;
transforming the output of said parsing into a mathematical model representing at least one meaning of the text, wherein an output of said parsing provides a parse tree as an acyclic graph that connects a plurality of groups based upon their relationship in a sentence, and further comprising examining said parse tree to create one or more concepts for a sentence;
grouping of concepts to define an object, wherein such concepts are grouped according to the subject to describe an event or entity;
outputting a set of event or entity types for a document;
feeding an event to a statistical classifier configured to identify a pre-defined or user-defined event or entity to determine whether said event or entity corresponds to a pre-defined or user-defined classifier type; and
classifying said event or entity into one or more categories.
